(19) United States
(12) Patent Application Publication
(10) Pub. No.: US 2014/0101463 A1
(43) Pub. Date: Apr. 10, 2014

(54) Current Distribution System, Current Distribution Method, and Computer System Thereof

(71) Applicant: Wistron Corporation, New Taipei City (TW)

(72) Inventors: Pay-Lun JU, New Taipei City (TW); Shyh-Ching HUANG, New Taipei City (TW); Wen-Yang WU, New Taipei City (TW); Chieh-Yi LIN, New Taipei City (TW); Chien-I HSU, New Taipei City (TW)

(21) Appl. No.: 13/933,938

(22) Filed: Jul. 2, 2013

(30) Foreign Application Priority Data
Oct. 9, 2012 (TW) 101137322

(51) Int. Cl. G06F 1/26

(52) U.S. Cl. CPC G06F 1/26
USPC 713/300

(57) ABSTRACT

A current distribution system, a current distribution method, and a computer system thereof are disclosed. The current distribution system includes a main control unit, a first power supply device, and a second power supply device. The main control unit is used for generating a first control command and a second control command. The first and the second power supply devices are used for receiving a first and a second power signals from a first and a second power input ends. The first and the second power supply devices adjust the first and the second power signals to a first and a second power shunt signals base on the first and the second control command and output to a load device, then the main control unit distributes a proportion of the first power shunt signal to the second power shunt signal accordingly.

### BACKGROUND OF THE INVENTION

1. Field of the Invention

The present invention relates to a current distribution system, a current distribution method and a computer system thereof; more particularly, the present invention relates to a current distribution system, a current distribution method and a computer system thereof capable of adjusting an output current value.

2. Description of the Related Art

With the development of modern technology, computer systems have been widely applied in various kinds of conditions. A computer system usually needs to operate for a long time, therefore it is essential to stably supply power to the internal load of the computer system. Because a power supply device has a limited life, in order to long-term and stably supply power signals to the computer system, a computer system equipped with two power supply devices has been developed. By utilizing the two power supply devices to share currents for simultaneously supplying power signals to the internal load of the computer system, the service life of the power supply device can be prolonged.

However, in known prior arts, the computer system would control the two power supply devices to simultaneously output the same current values. That is, each of the two power supply devices carries out 50% of the load current; therefore, the two power supply devices consume the same energy, and would very likely break down at the same time. In this regard, there is not enough time for a user to replace new power supply devices, which may even cause damage to the computer system.

Therefore, there is a need to provide a current distribution system, a current distribution method, and a computer system thereof to mitigate and/or obviate the aforementioned problems.

### SUMMARY OF THE INVENTION

It is an object of the present invention to provide a current distribution system capable of adjusting an output current value.

It is another object of the present invention to provide a current distribution method.

It is yet another object of the present invention to provide a computer system including the abovementioned current distribution system.

To achieve the abovementioned objects, the current distribution system of the present invention is used in a computer system, and is used for adjusting powers supplied from a first power input end and a second power input end to a load device. The current distribution system comprises a main control unit, a first power supply device, and a second power supply device. The main control unit is used for generating a first control command and a second control command. The first power supply device is electrically connected to the main control unit and the first power input end, and is used for receiving a first power signal from the first power input end. The first power supply device includes a first control module and a first current adjustment module. The first control module is electrically connected to the main control unit, so as to receive the first control command from the main control unit. The first current adjustment module is electrically connected to the first control module and the first power input end, so as to receive the first power signal, wherein the first control module controls the first current adjustment module to adjust a current value of the first power signal into a first power shunt signal according to the first control command, and outputs the first power shunt signal to the load device. The second power supply device is electrically connected to the main control unit and the second power input end, and is used for receiving a second power signal from the second power input end. The second power supply device includes a second control module and a second current adjustment module. The second control module is electrically connected to the main control unit, so as to receive the second control command from the main control unit. The second current adjustment is electrically connected to the second control module and the second power input end, so as to receive the second power signal, wherein the second control module controls the second current adjustment module to adjust a current value of the second power signal into a second power shunt signal according to the second control command, and outputs the second power shunt signal to the load device. The main control unit distributes a proportion of the first power shunt signal to the second power shunt signal accordingly, wherein a summation of a current value of the first power shunt signal and a current value of the second power shunt signal is a fixed value.

The current distribution method of the present invention comprises the following steps: receiving a first initial power signal and a second initial power signal from a first power supply device and a second power supply device; calculating a summation of a current value of the first initial power signal and a current value of the second initial power signal; setting a proportion of a first power shunt signal to a second power shunt signal, wherein a summation of a current value of the first power shunt signal and a current value of the second power shunt signal is equal to the summation of the current value of the first initial power signal and the current value of the second initial power signal; controlling the first power supply device to adjust a current value of the first initial power signal into the first power shunt signal; and controlling the second power supply device to adjust a current value of the second initial power signal into the second power shunt signal.

The computer system of the present invention comprises a first power input end, a second power input end, a load device and a current distribution system. The first power input end is used for outputting a first power signal. The second power input end is used for outputting a second power signal. The current distribution system comprises a main control unit, a first power supply device and a second power supply device. The main control unit is used for generating a first control command and a second control command. The first power supply device is electrically connected to the main control unit and the first power input end, and is used for receiving the first power signal from the first power input end. The first power supply device includes a first control module and a first current adjustment module. The first control module is electrically connected to the main control unit, so as to receive the first control command from the main control unit. The first current adjustment module is electrically connected to the first control module and the first power input end, so as to receive the first power signal, wherein the first control module controls the first current adjustment module to adjust a current value of the first power signal into a first power shunt signal according to the first control command, and outputs the first power shunt signal to the load device. The second power supply device is electrically connected to the main control unit and the second power input end, and is used for receiving the second power signal from the second power input end. The second power supply device includes a second control module and a second current adjustment module. The second control module is electrically connected to the main control unit, so as to receive the second control command from the main control unit. The second current adjustment module is electrically connected to the second control module and the second power input end, so as to receive the second power signal, wherein the second control module controls the second current adjustment module to adjust a current value of the second power signal into a second power shunt signal according to the second control command, and outputs the second power shunt signal to the load device. The main control unit distributes a proportion of the first power shunt signal to the second power shunt signal accordingly, wherein a summation of a current value of the first power shunt signal and a current value of the second power shunt signal is a fixed value.

Other objects, advantages, and novel features of the invention will become more apparent from the following detailed description when taken in conjunction with the accompanying drawings.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1A illustrates a hardware architecture of a current distribution system in an initial state of the present invention.

FIG. 1B illustrates a hardware structure of the current distribution system in a current distributing state of the present invention.

FIG. 2A illustrates a circuit schematic drawing of a first power supply device of the current distribution system of the present invention.

FIG. 2B illustrates a circuit schematic drawing of a second power supply device of the current distribution system of the present invention.

FIG. 3 illustrates a circuit schematic drawing showing a main control unit connected to each module of the current distribution system of the present invention.

FIGS. 4A-4B illustrate flowcharts of a current distribution method according to the present invention.

### DETAILED DESCRIPTION OF THE PREFERRED EMBODIMENT

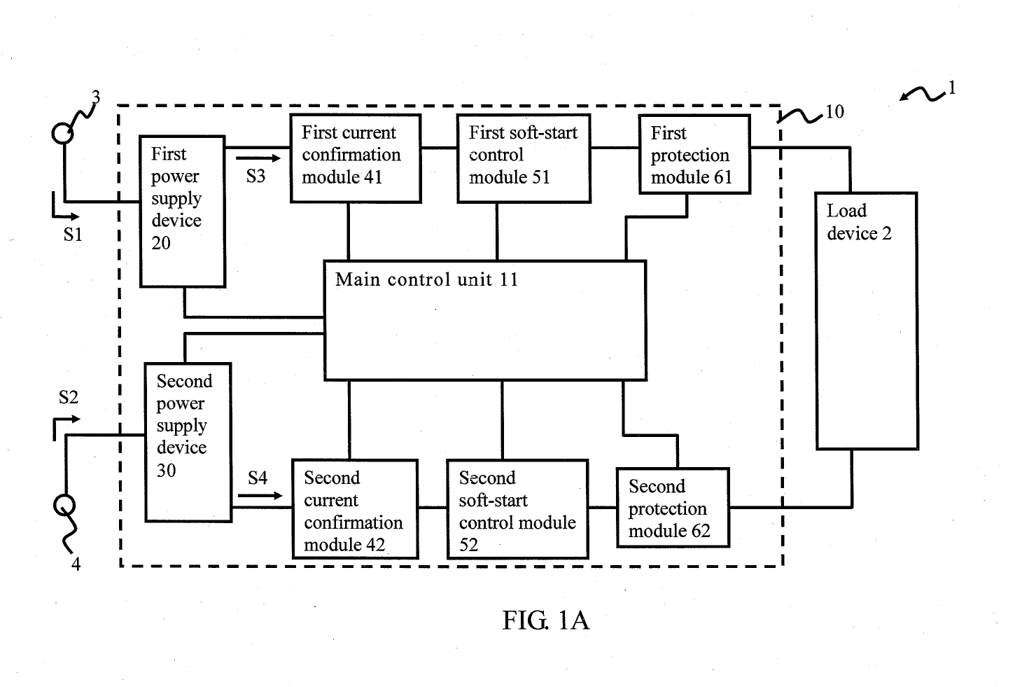

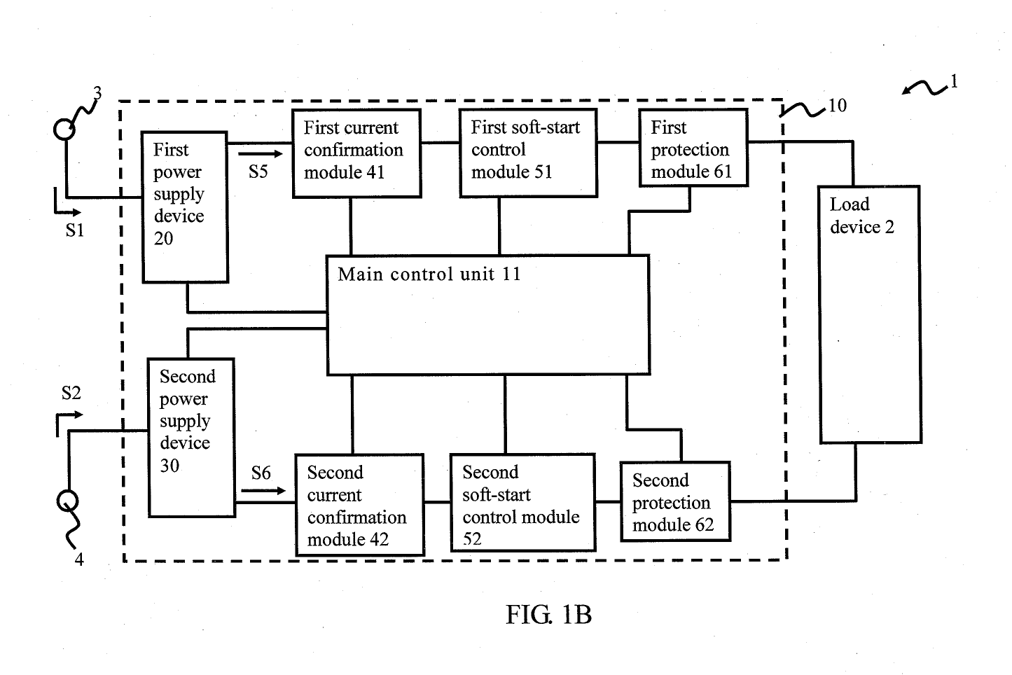

Please refer to FIG. 1A, which illustrates a hardware architecture of a current distribution system in an initial state of the present invention.

The current distribution system 10 of the present invention is used in a computer system 1, so as to supply power required by a load device 2 in the computer system 1. The computer system 1 can be a desktop computer, a server computer, or any other equivalent system without limiting to the abovementioned systems. The load device 2 can be a motherboard, an access device, an interface card or any other device which needs to receive a power signal for operation in the computer system 1. A first power input end 3 and a second power input end 4 are electrically connected to the current distribution system 1, and are used for supplying a first power signal S1 and a second power signal S2. After being through a current distribution process performed by the current distribution system 10, the first power signal S1 and the second power signal S2 are then transmitted to the load device 2.

The current distribution system 10 comprises a main control unit 11, a first power supply device 20, a second power supply device 30, a first current confirmation module 41, a second current confirmation module 42, a first soft-start control module 51, a second soft-start control module 52, a first protection module 61, and a second protection module 62. The first power supply device 20 is electrically connected to the main control unit 11 and the first power input end 3. The second power supply device 30 is electrically connected to the main control unit 11 and the second power input end 4. After the first power supply device 20 and the second power supply device 30 are installed in the computer system 1, the first power supply device 20 and the second power supply device 30 would receive the first power signal S1 and the second power signal S2 respectively from the first power input end 3 and the second power input end 4. Then, the first power supply device 20 and the second power supply device 30 respectively convert the first power signal S1 and the second power signal S2 into a first initial power signal S3 and a second initial power signal S4 for being supplied to the load device 2. The first initial power signal S3 and the second initial power signal S4 can both have, but not limited to, a voltage value of 12 volts. Please note that the first initial power signal S3 and the second initial power signal S4 can be adjusted according to a voltage value which the load device 2 can afford.

The main control unit 11 can be made of hardware, hardware combined with firmware, or hardware combined with software. For example, the main control unit 11 can be, but not limited to, a microcontroller unit. The main control unit 11 can be used for controlling and distributing a current proportion of power signals supplied by the first power supply device 20 and the second power supply device 30. For example, the first power supply device 20 supplies 30% of a load current, and the second power supply device 30 supplies 70% of the load current. Or, the first power supply device 20 supplies 10% of the load current, and the second power supply device 30 supplies 90% of the load current. As a result, the loading to one of the power supply devices can be reduced, so as to avoid the situation that the first power supply device 20 and the second power supply device 30 break down at the same time. Furthermore, the main control unit 11 is capable of distributing the first power supply device 20 to supply 100% of the load current, and the second power supply device 30 to supply 0% of the load current at first. Then the main control unit 11 controls the second power supply device 30 to supply 100% of the load current when the first power supply device 20 is fault. Besides, a power supply efficiency of the first power supply device can be superior to a power supply efficiency of the second power supply device. As a result, the computer system 1 can controls the first power supply device 20 with the superior power supply efficiency to supply the power and allows the second power supply device 30 to be a backup device, so as to save the cost.

As shown in FIG. 1B, which illustrates a hardware architecture of the current distribution system in a current distributing state of the present invention. For example, when the summation of currents of the first initial power signal S3 and the second initial power signal S4 outputted by the first power supply device 20 and the second power supply device 30 is 10 amperes, if the first power supply device 20 is set to carry out 30% of the load current and the second power supply device 30 is set to carry out 70% of the load current, the main control unit 11 generates a first control command to the first power supply device 20, such that the first power supply device 20 generates a first power shunt signal S5 of 3 amperes; meanwhile, the main control unit 11 generates a second control command to the second power supply device 30, such that the second power supply device 30 generates a second power shunt signal S6 of 7 amperes. Moreover, if the first power supply device 20 is set to carry out 10% of the load current and the second power supply device 30 is set to carry out 90% of the load current, the main control unit 11 controls the first power supply device 20 to generate the first power shunt signal S5 of 1 ampere, and meanwhile controls the second power supply device 30 to generate the second power shunt signal S6 of 9 amperes. Therefore, the main control unit 11 distribute the first power supply device 20 and the second power supply device 30 to respectively output different but mutually-correlating first power shunt signal S5 and second power shunt signal S6, wherein the summation of current values of the first power shunt signal S5 and the second power shunt signal S6 is a fixed value, which is equal to the summation of current values of the first initial power signal S3 and the second initial power signal S4.

Further, before the main control unit 11 controls the first power supply device 20 and the second power supply device 30, the main control unit 11 firstly reads a first identification code of the first power supply device 20, and a second identification code of the second power supply device 30. The main control unit 11 identifies model types of the first power supply device 20 and the second power supply device 30 according to the first identification code and the second identification code, so as to confirm whether the first power supply device 20 and the second power supply device 30 have the function of current adjustment. If the first power supply device 20 or the second power supply device 30 cannot adjust its output current value, it is certain that the main control unit 11 cannot execute a current distribution procedure to the power signal.

The first current confirmation module 41 and the second current confirmation module 42 enable the main control unit 11 to confirm whether the current values of the first power shunt signal S5 outputted by the first power supply device 20 and the second power shunt signal S6 outputted by the second power supply device 30 correspond to a setting requirement of the main control unit 11. The first soft-start control module 51 and the second soft-start control module 52 are used for suppressing peak currents which may possibly be generated while inputting the first power shunt signal S5 and the second power shunt signal S6, so as to protect the computer system 1 and its internal load device 2. The first protection module 61 and the second protection module 62 are used for preventing the second power shunt signal S6 of the second power supply device 30 from reverse-flowing to the first power supply device 20, as well as for preventing the first power shunt signal S5 of the first power supply device 20 from reverse-flowing to the second power supply device 30. The operation of each of the abovementioned elements will be described in detail hereinafter.

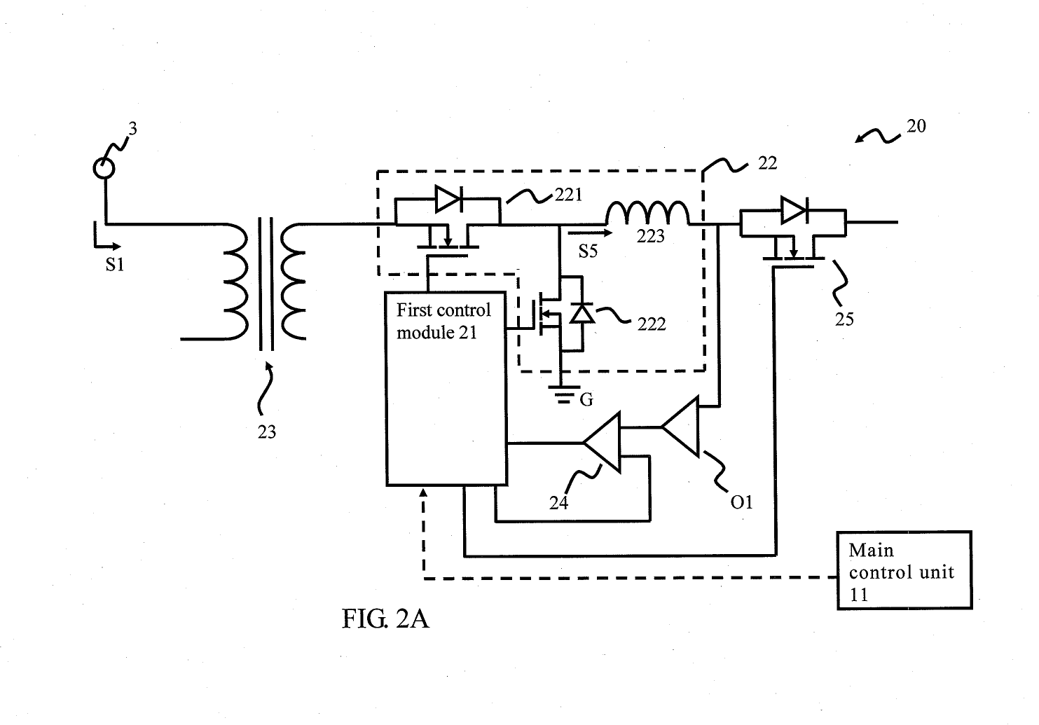

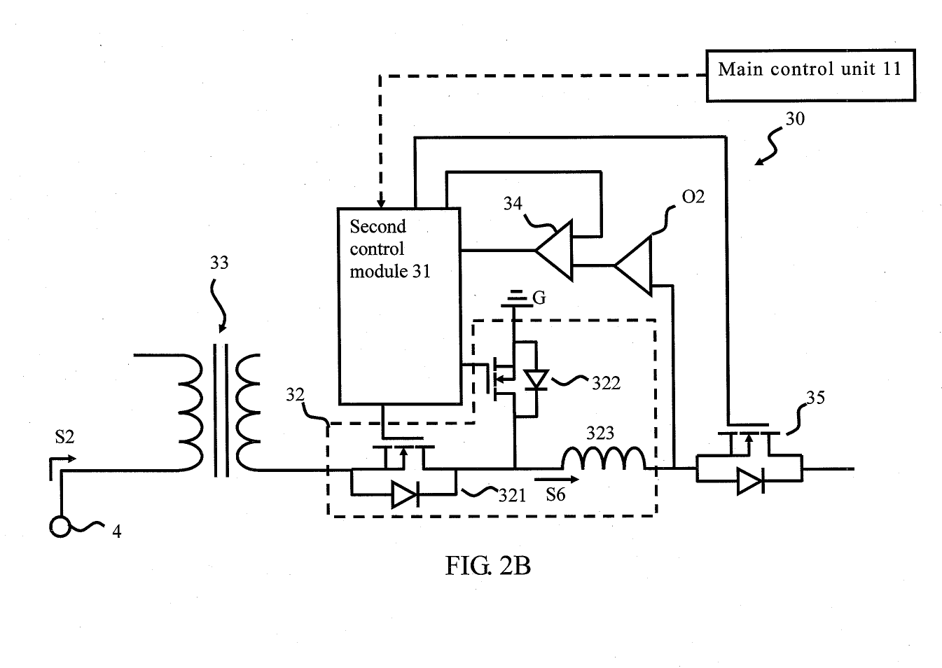

Next, please refer to FIG. 2A, which illustrates a circuit schematic drawing of the first power supply device of the current distribution system of the present invention.

The first power supply device 20 can comprise a first control module 21, a first current adjustment module 22, a first voltage transformer 23, a first comparator 24, and a first protection switch 25. The first control module 21 is electrically connected to the main control unit 11, and is similar with the main control unit 11; that is, both of the first control module 21 and the main control unit 11 can be microcontroller units, but please note that the scope of the present invention is not limited to the above description. When the main control unit 11 is going to adjust the current value, it firstly generates the first control command to the first control module 21.

The first current adjustment module 22 is electrically connected to the first power input end 3 and the first control module 21, so as to receive the first power signal S1 from the first power input end 3, and to further adjust the current value of the first power signal S1 into the first power shunt signal S5 according to the control of the first control module 21. The first current adjustment module 22 can comprises a first switch module 221, a second switch module 222, and a first energy storage element 223. The first switch module 221 is electrically connected to the first power input end 3 and the first control module 21; the second switch module 222 is electrically connected to the first control module 21, the first switch module 221, and a ground end G; and the first energy storage element 223 is electrically connected to the first switch module 221 and the second switch module 222. The first switch module 221 and the second switch module 222 can both be an element made of metal-oxide-semiconductor field-effect transistor (MOSFET) combined with a diode; and the first energy storage element 223 can be an inductive element with energy storage functionality; however, please note that the scope of the present invention is not limited to the abovementioned elements. According to the received first control command, the first control module 21 generates a pulse width modulation signal to adjust the first switch module 221, so as to generate the first power shunt signal S5 with an adjusted current value. The first power shunt signal S5 would be outputted after passing through the first energy storage element 223; therefore, the first energy storage element 223 can also store energy at this time. Then, the first control module 21 controls the first switch module 22a to turn off and controls the second switch module 222 to turn on, such that the first energy storage element 223 can release energy accordingly, so as to output the first power shunt signal S5. Therefore, the first control module 21 utilizes the pulse width modulation signal to continuously control the first switch module 221 to turn on and the second switch module 222 to turn off, as well as control the first switch module 221 to turn off and the second switch module 222 to turn on, thereby continuously outputting the first power shunt signal S5 with the adjusted current value.

The first power supply device 20 can further comprise the first voltage transformer 23 depending on its requirement. If the first power signal S1 inputted by the first power input end 3 is an alternating current, or has a current value that the load device 2 cannot afford, the first voltage transformer 23 would firstly perform voltage transformation, such as converting the first power single S1 as the alternating current into the first power signal S1 as a direct current.

The first comparator 24 is electrically connected to the first energy storage element 223 and the first control module 21. At the time the first energy storage element 223 outputs the first power shunt signal S5, the first comparator 24 compares the first power shunt signal S5 with the pulse width modulation signal of the first control module 21, such that the first control module 21 can be aware whether the current value of the first power shunt signal S5 attains a required adjusted value, so as to control the frequency of switching the first switch module 221 and the second switch module 222. Further, the first comparator 24 can also be connected to an amplifier O1, so as to utilize the amplifier O1 to amplify the signal and thereby increasing the accuracy of comparison.

Finally, the first protection switch 25 is installed in a transmission path of the first power shunt signal S5, and is electrically connected to the first control module 21. If the first power supply device 20 encounters a breakdown or has other abnormal situation, the first control module 21 can then directly control the first protection switch 25 to cut out the output of the first power shunt signal S5. The first protection switch 25 can also be, but not limited to, an element made of metal-oxide-semiconductor field-effect transistor combined with a diode.

Then, please refer to FIG. 2B, which illustrates a circuit schematic drawing of the second power supply device of the current distribution system of the present invention.

Similar to the first power supply device 20, the second power supply device 30 can also comprise a second control module 31, a second current adjustment module 32, a second voltage transformer 33, a second comparator 34, and a second protection switch 35. The second control module 31 is electrically connected to the main control unit 11, both of which can be, but not limited to, microcontroller units. When the main control unit 11 is going to generate the first control command to the first control module 21 for adjusting the current value outputted by the first power supply device 20, the main control unit 11 can also simultaneously generate the second control command to the second control module 31 for adjusting the current value.

The second current adjustment module 32 is electrically connected to the second power input end 4 and the second control module 31, so as to receive the second power signal S2 from the second power input end 4, and to further adjust the current value of the second power signal S2 into the second power shunt signal S6 according to the control of the second control module 31. The second current adjustment 32 can also comprise a third switch module 321, a fourth switch module 322, and a second energy storage element 323. The third switch module 321 is electrically connected to the second power input end 4 and the second control module 31; the fourth switch module 322 is electrically connected to the second control module 31, the third switch module 321, and a ground end G; and the second energy storage element 323 is electrically connected to the third switch module 321 and the fourth switch module 322. Similar to the operation of the first current adjustment module 22, the second control module 31 utilizes a pulse width modulation signal to continuously control the third switch module 321 to turn on and the fourth switch module 322 to turn off, as well as control the third switch module 321 to turn off and the fourth switch module 322 to turn on, thereby continuously outputting the second power shunt signal S6 with the adjusted current value through the second energy storage element 323.

Similarly, the second power supply device 30 can comprise the second voltage transformer 33 depending on its requirement. If the second power signal S2 inputted by the second power input end 4 is an alternating current, or has a current value that the load device 2 cannot afford, the second voltage transformer 33 would firstly perform voltage transformation, such as converting the second power signal S2 as the alternating current into the second power signal S2 as a direct current. Moreover, the first power input end 3 and the second power input end 4 can generate the same of different types of current signals. For example, the first power signal S1 and the second power signal S2 can both be alternating current signals of 200 to 240 volts and 50/60 Hz. Or, one of the first power single S1 and the second power signal S2 is an alternating current signal, while another is a direct current signal. Therefore, no matter what types of signals do the first power signal S1 and the second power signal S2 belong to, the first power supply device 20 and the second power supply device 30 can both obtain required voltage values by installing the first voltage transformer 23 and the second voltage transformer 33.

The second comparator 34 is electrically connected to the second energy storage element 323 and the second control module 31. At the time the second energy storage element 323 outputs the second power shunt signal S6, the second comparator 34 compares the second power shunt signal S6 with the pulse width modulation signal of the second control module 31, such that the second control module 31 can be aware whether the current value of the second power shunt signal S6 attains a required adjusted value, so as to control the frequency of switching the third switch module 321 and the fourth switch module 322. Further, an amplifier O2 can be utilized to amplify the signal and thereby increasing the accuracy of comparison.

Finally, the second protection switch 35 is installed in a transmission path of the second power shunt signal S6, and is electrically connected to the second control module 31. If the second power supply device 30 encounters a breakdown or has other abnormal situation, the second control module 31 can then directly control the second protection switch 35 to cut out the output of the second power shunt signal S6. Because each of the internal elements in the second power supply device 30 operates the same as each of the internal elements in the first power supply device 20 does, there is no need for further explanation regarding the operation.

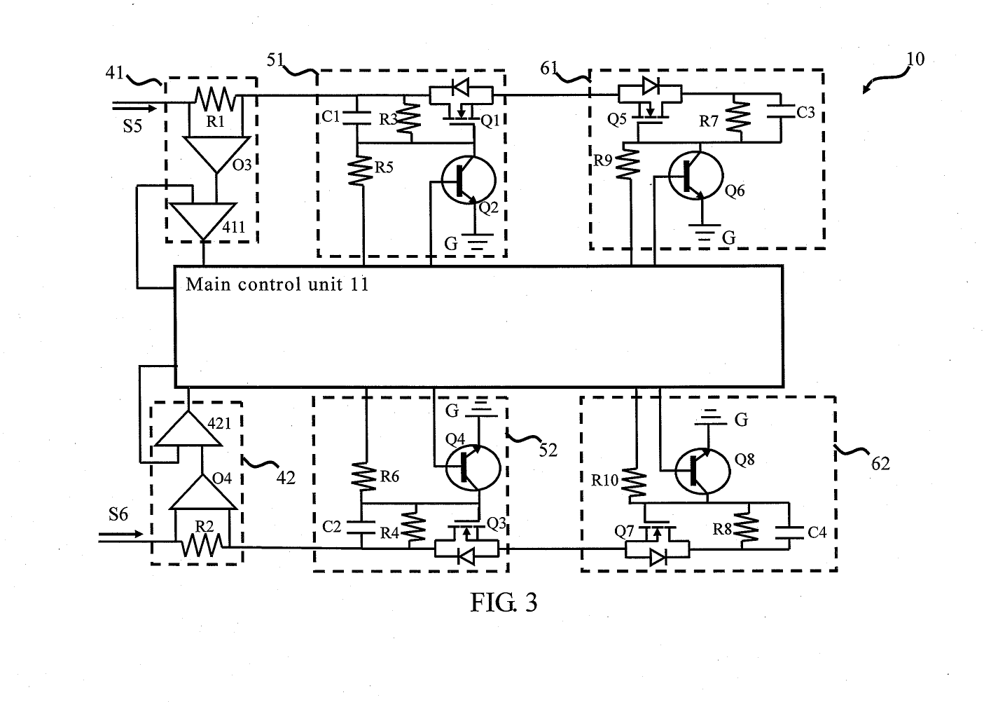

Then, please refer to FIG. 3, which illustrates a circuit schematic drawing showing the main control unit connected to each module of the current distribution system of the present invention.

The first current confirmation module 41 comprises a resistance element R1, an amplifier O3, and a comparator 411. When the first power shunt signal S5 flows through the resistance element R1, the amplifier O3 amplifies the current signal of the resistance element R1 and transmits it to the comparator 411. The comparator 411 compares the current signal with a predetermined current distribution value of the main control unit 11, so as to determine whether the current value of the first power shunt signal S5 corresponds to a current value required by the first control command of the main control unit 11.

Similarly, the second current confirmation module 42 comprises a resistance element R2, an amplifier O4, and a comparator 421. When the second power shunt signal S6 flows through the resistance element R2, the amplifier O4 amplifies the current signal of the resistance element R2 and transmits it to the comparator 421 for comparison. Therefore, according to the comparator 421, the main control unit 11 can similarly determine whether the current value of the second power shunt signal S6 corresponds to a current value required by the second control command of the main control unit 11. If the current value of any of the abovementioned power shunt signals does not meet the requirement, the main control unit 11 would continuously output the control command to the first power supply device 20 or the second power supply device 30 for further adjustment.

The first soft-start control module 51 comprises transistor elements Q1 and Q2, a capacitance element C1, and resistance elements R3 and R5. The transistor element Q1 is electrically connected to the main control unit 11. The transistor element Q2 is electrically connected to the main control unit 11, the transistor element Q1, and a ground end G. According to characteristics of the capacitance element C1 and the resistance elements R3 and R5, as well as the control from the main control unit 11 to the transistor element 1, the peak current which may possibly be generated while inputting the first power shunt signal S5 can be suppressed, so as to protect the computer system 1 and its internal load device 2. The main control unit 11 can also utilize the transistor element Q2 to directly shut down the transistor element Q1, so as to let the first power supply device 20 stop supplying power.

Likewise, the second soft-start control module 52 comprises transistor elements Q3 and Q4, a capacitance element C2, and resistance elements R4 and R6. The transistor element Q3 is electrically connected to the main control unit 11. The transistor element Q4 is electrically connected to the main control unit 11, the transistor element Q3, and a ground end G. According to characteristics of the capacitance element C2 and the resistance elements R4 and R6, as well as the control from the main control unit 11 to the transistor element Q3, the peak current which may possibly be generated while inputting the second power shunt signal S6 can be suppressed, so as to protect the load device 2. The main control unit 11 can also utilize the transistor element Q4 to directly shut down the transistor element Q3, so as to let the second power supply device 30 stop supplying power.

Finally, the first protection module 61 comprises transistor elements Q5 and Q6, a capacitance element C3, and resistance elements R7 and R9. The transistor element Q5 is electrically connected to the main control unit 11. The transistor element Q6 is electrically connected to the main control unit 11, the transistor element Q5, and a ground end G. The transistor element Q5 is used as an element for reverse current blocking, so as to prevent the second power shunt signal S6 of the second power supply device 30 from reverse-flowing to the first power supply device 20 according to the control of the main control unit 11. The main control unit 11 can also utilize the transistor element Q6 to directly shut down the transistor element Q5, so as to let the first power supply device 20 stop supplying power.

Similarly, the second protection module 62 also comprises transistor elements Q7 and Q8, a capacitance element C4, and resistance elements R8 and R10. The transistor element Q7 is electrically connected to the main control unit 11. The transistor element Q8 is electrically connected to the main control unit 11, the transistor element Q7, and a ground end G. The transistor element Q7 is used as an element for reverse current blocking, so as to prevent the first power shunt signal S5 of the first power supply device 20 from reverse-flowing to the second power supply device 30 according to the control of the main control unit 11. The main control unit 11 can also utilize the transistor element Q8 to directly shut down the transistor element Q7, so as to let the second power supply device 30 stop supplying power.

Please note that the transistor elements Q1 to Q8 are not limited to be metal-oxide-semiconductor field-effect transistors (MOSFET) or bipolar junction transistors (BJT). What illustrated in FIG. 3 is only one of the implementations for an illustration purpose; please note that the scope of the present invention is not limited to the above description.

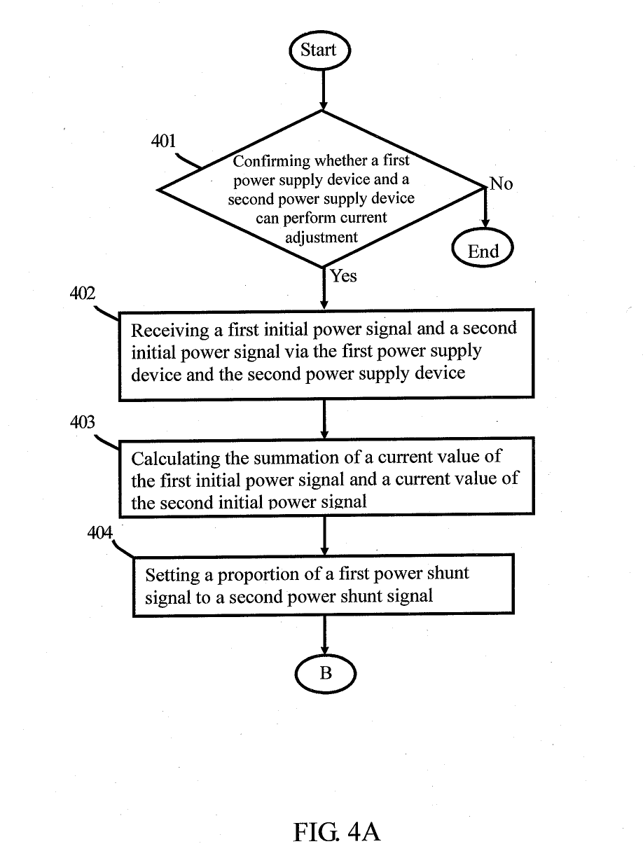

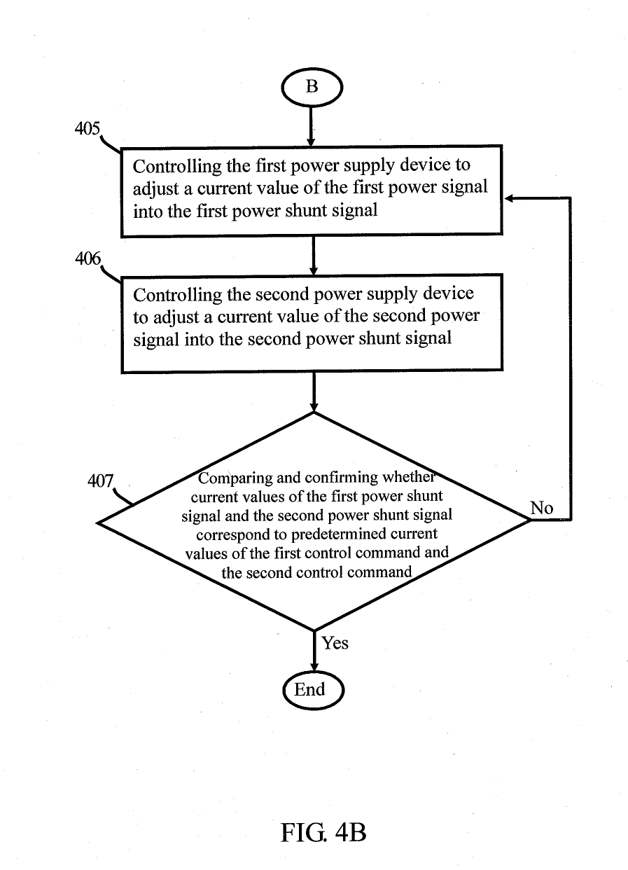

Then, please refer to FIGS. 4A-4B, which illustrate flowcharts of a current distribution method of the present invention. Please note that in the following embodiment, the current distribution system 10 is used as an example for explaining the current distribution method of the present invention; however, the current distribution method of the present invention is not limited to be applied to the current distribution system 10 with exactly the same circuit composition.

Firstly, the method performs step 401: confirming whether a first power supply device and a second power supply device can perform current adjustment.

At first, when the first power supply device 20 and the second power supply device 30 are installed in the computer system 1, the main control unit 11 firstly reads a first identification code of the first power supply device 20, and a second identification code of the second power supply device 30, so as to determine, according to the first identification code and the second identification code, whether the first power supply device 20 and the second power supply device 30 are capable of adjusting output current values. If one of the power supply devices cannot perform current adjustment, it is certain that the main control unit 11 cannot execute the current distribution procedure. Therefore, after the main control unit 11 confirms that the first power supply device 20 and the second power supply device 30 are both capable of performing current adjustment, the main control unit 11 can then execute following steps.

Then, after confirming that the first power supply device 20 and the second power supply device 30 can both perform current adjustment, the method performs step 402: receiving a first initial power signal and a second initial power signal via the first power supply device and the second power supply device.

Then, the first power supply device 20 receives the first power signal S1 transmitted from the first power input end 3, and meanwhile converts it into the first initial power signal S3 for being directly outputted to the load device 2. The voltage value of the first initial power signal S3 can be 12 volts so as to meet the requirement of the load device 2. Likewise, the second power supply device 30 receives the second power signal S2 transmitted from the second power input end 4, and meanwhile converts it into the second initial power signal S4 of 12 volts for being directly outputted to the load device 2.

Next, the method performs step 403: calculating the summation of a current value of the first initial power signal and a current value of the second initial power signal.

Next, the main control unit 11 firstly calculates the summation of the current value of the first initial power signal S3 and the current value of the second initial power signal. S4. In the initial condition, the current value of the first initial power signal S3 and the current value of the second initial power signal S4 should be the same; that is, the first power supply device 20 and the second power supply device 30 respectively carry out 50% of the load current.

Then, the method performs step 404: setting a proportion of a first power shunt signal to a second power shunt signal.

Then, the main control unit 11 sets a proportion of the load current which the first power supply device 20 and the second power supply device 30 need to carry out respectively, so as to adjust the current values of the first power shunt signal S5 and the second power shunt signal S6 accordingly. The summation of the current values of the first power shunt signal S5 and the second power shunt signal S6 is equal to the summation of the current values of the first initial power signal S3 and the second initial power signal S4. For example, the summation of the current values of the first initial power signal S3 and the second initial power signal S4 is 10 amperes. If the main control unit 11 requests the first power supply device 20 to carry out 30% of the load current, and the second power supply device 30 to carry out 70% of the load current, the main control unit 11 would set the first power supply device 20 to lower the current value of the first power shunt signal S5 to 3 amperes, and at the same time set the second power supply device 30 to raise the current value of the second power shunt signal S6 to 7 amperes.

Then, the method performs step 405: controlling the first power supply device to adjust a current value of the first power signal into the first power shunt signal.

Then, the main control unit 11 generates the first control command to the first control module 21 of the first power supply device 20, such that the first control module 21 controls the first current adjustment module 22 to adjust the original first power signal S1 into the first power shunt signal S5 of 3 amperes.

Meanwhile, the method performs step 406: controlling the second power supply device to adjust a current value of the second power signal into the second power shunt signal.

In order to keep the stability of the total current, at the time the main control unit 11 controls the first power supply device 20, the main control unit 11 would also generate the second control command to the second control module 31 of the second power supply device 30, such that the second control module 31 controls the second current adjustment module 32 to adjust the second power signal S2, so as to output the second power shunt signal S6 of 7 amperes.

Finally, the method performs step 407: comparing and confirming whether current values of the first power shunt signal and the second power shunt signal correspond to predetermined current values of the first control command and the second control command.

Finally, the first current confirmation module 41 or the first comparator 24 can simultaneously or respectively confirm whether the first power shunt signal S5 corresponds to a predetermined current value of the first control command; and the second current confirmation module 42 or the second comparator 34 can also simultaneously or respectively confirm whether the second power shunt signal S6 corresponds to a predetermined current value of the second control command. If the predetermined current value is not attained yet, the method returns to step 405 to let the first power supply device 20 or the second power supply device 30 to keep adjusting. If the predetermined current value has been attained, the current distribution procedure ends.

Please note that the current distribution method of the present invention is not limited to the abovementioned step sequences and orders. The step sequences and orders can be altered as long as the object of the present invention can be achieved.

According to the abovementioned current distribution system 10, the computer system 1 can distribute the currents that the first power supply device 20 and the second power supply device 30 need to carry out. Besides, the computer system 1 can controls the first power supply device 20 with the superior supply efficiency to supply the power and allows the inexpensive second power supply device 30 to be a backup device, so as to save the electricity and the cost. Therefore, when one of the power supply devices breaks down, the other power supply device can still be used to supply power, such that the user can have time to replace a new power supply device.

Although the present invention has been explained in relation to its preferred embodiments, it is to be understood that many other possible modifications and variations can be made without departing from the spirit and scope of the invention as hereinafter claimed.

1. A current distribution system, used in a computer system, for adjusting powers supplied from a first power input end and a second power input end to a load device, the current distribution system comprising:
a main control unit, used for generating a first control command and a second control command;
a first power supply device, electrically connected to the main control unit and the first power input end, used for receiving a first power signal from the first power input end, the first power supply device comprising:
a first control module, electrically connected to the main control unit, so as to receive the first control command from the main control unit; and
a first current adjustment module, electrically connected to the first control module and
the first power input end, so as to receive the first power signal, wherein the first control module controls the first current adjustment module to adjust a current value of the first power signal into a first power shunt signal according to the first control command, and outputs the first power shunt signal to the load device;
and
a second power supply device, electrically connected to the main control unit and the second power input end, used for receiving a second power signal from the second power input end, the second power supply device comprising:
a second control module, electrically connected to the main control unit, so as to receive the second control command from the main control unit; and
a second current adjustment module, electrically connected to the second control module and the second power input end, so as to receive the second power signal, wherein the second control module controls the second current adjustment module to adjust a current value of the second power signal into a second power shunt signal according to the second control command, and outputs the second power shunt signal to the load device;
wherein the main control unit distributes a proportion of the first power shunt signal to the second power shunt signal accordingly, wherein a summation of a current value of the first power shunt signal and a current value of the second power shunt signal is a fixed value.

2. The current distribution system as claimed in claim 1, wherein:
the first current adjustment module comprises:
a first switch module, electrically connected to the first control module and the first power input end;
a second switch module, electrically connected to the first control module and the first switch module; and
a first energy storage element, electrically connected to the first switch module and the second switch module; wherein the first control module simultaneously controls the first switch module and the second switch module to respectively turn on or off according to the first control command, so as to adjust the current value of the first power signal into the first power shunt signal accordingly, and to output the first power shunt signal to the load device via the first energy storage element;
and
the second current adjustment module comprises:
a third switch module, electrically connected to the second control module and the second power input end;
a fourth switch module, electrically connected to the second control module and the third switch module; and
a second energy storage element, electrically connected to the third switch module and the fourth switch module; wherein the second control module simultaneously controls the third switch module and the fourth switch module to respectively turn on or off according to the second control command, so as to adjust the current value of the second power signal into the second power shunt signal accordingly, and to output the second power shunt signal to the load device via the second energy storage element.

3. The current distribution system as claimed in claim 1, wherein the first power supply device further comprises a first voltage transformer, and the first voltage transformer is electrically connected between the first power input end and the first switch module, so as to receive the first power signal as an alternating current signal and convert it into the first power signal as a direct current signal.

4. The current distribution system as claimed in claim 1, wherein the second power supply device further comprises a second voltage transformer, and the second voltage transformer is electrically connected between the second power input end and the third switch module, so as to receive the second power signal as an alternating current signal and convert it into the second power signal as a direct current signal.

5. The current distribution system as claimed in claim 1, wherein the main control unit is connected to a first current confirmation module and a second current confirmation module, where the first current confirmation module compares and confirms whether the current value of the first power shunt signal corresponds to a predetermined current value of the first control command, and the second current confirmation module compares and confirms whether the current value of the second power shunt signal corresponds to the predetermined current value of the second control command.

6. The current distribution system as claimed in claim 1, wherein the main control unit is connected to a first soft-start control module and a second soft-start control module, where the first soft-start control module controls the output of the first power shunt signal to protect the load device, and the second soft-start control module controls the output of the second power shunt signal to protect the load device.

7. The current distribution system as claimed in claim 1, wherein the main control unit is connected to a first protection module and a second protection module, wherein the first protection module prevents the second power shunt signal from reverse-flowing to the first power supply device, and the second protection module prevents the first power shunt signal from reverse-flowing to the second power supply device.

8. The current distribution system as claimed in claim 1, wherein:
the first power supply device further comprises a first comparator, used for comparing and confirming whether the current value of the first power shunt signal corresponds to a control current value of the first control module; and
the second power supply device further comprises a second comparator, used for comparing and confirming whether the current value of the second power shunt signal corresponds to a control current value of the second control module.

9. The current distribution system as claimed in claim 1, wherein:
the first power supply device further comprises a first protection switch, used for controlling the output of the first power shunt signal; and
the second power supply device further comprises a second protection switch, used for controlling the output of the second power shunt signal.

10. The current distribution system as claimed in claim 1, wherein the main control unit further identifies a first identification code of the first power supply device and a second identification code of the second power supply device, so as to confirm that the first power supply device and the second power supply device can perform current adjustment.

11. The current distribution system as claimed in claim 1, wherein the main control unit further distributes the first power supply device to supply 100% of a load current, and the second power supply device to supply 0% of the load current, and controls the second power supply device to supply 100% of the load current when the first power supply device is fault.

12. The current distribution system as claimed in claim 11, wherein a power supply efficiency of the first power supply device is superior to a power supply efficiency of the second power supply device.

13. A current distribution method, used in a current distribution system of a computer system, for adjusting powers supplied from a first power input end and a second power input end to a load device, the current distribution system comprising a main control unit, a first power supply device and a second power supply device, the current distribution method comprising the following steps:
receiving a first initial power signal and a second initial power signal from the first power supply device and the second power supply device;
calculating a summation of a current value of the first initial power signal and a current value of the second initial power signal;
setting a proportion of a first power shunt signal to a second power shunt signal, wherein a summation of a current value of the first power shunt signal and a current value of the second power shunt signal is equal to the summation of the current value of the first initial power signal and the current value of the second initial power signal;
controlling the first power supply device to adjust a current value of the first initial power signal into the first power shunt signal; and
controlling the second power supply device to adjust a current value of the second initial power signal into the second power shunt signal.

14. The current distribution method as claimed in claim 13 further comprising the following steps:
comparing and confirming whether the current value of the first current shunt signal corresponds to a predetermined current value of a first control command; and
comparing and confirming whether the current value of the second power shunt signal corresponds to a predetermined current value of a second control signal.

15. The current distribution method as claimed in claim 13 further comprising the step of:
identifying a first identification code of the first power supply device and a second identification code of the second power supply device in advance, so as to confirm whether the first power supply device and the second power supply device can perform current adjustment.

16. A computer system, comprising:
a first power input end, used for outputting a first power signal;
a second power input end, used for outputting a second power signal;
a load device; and
a current distribution system, electrically connected to the first power input end, the second power input end, and the load device, the current distribution system comprising:
a main control unit, used for generating a first control command and a second control command;
a first power supply device, electrically connected to the main control unit and the first power input end, used for receiving the first power signal from the first power input end, the first power supply device comprising:
a first control module, electrically connected to the main control unit, so as to receive the first control command from the main control unit; and
a first current adjustment module, electrically connected to the first control module and the first power input end, so as to receive the first power signal, wherein the first control module controls the first current adjustment module to adjust a current value of the first power signal into a first power shunt signal according to the first control command, and outputs the first power shunt signal to the load device;
a second power supply device, electrically connected to the main control unit and the second power input end, used for receiving the second power signal from the second power input end, the second power supply device comprising:
a second control module, electrically connected to the main control unit, so as to receive the second control command from the main control unit; and
a second current adjustment module, electrically connected to the second control module and the second power input end, so as to receive the second power signal, wherein the second control module controls the second current adjustment module to adjust a current value of the second power signal into a second power shunt signal according to the second control command, and outputs the second power shunt signal to the load device;
wherein the main control unit distributes a proportion of the first power shunt signal to the second power shunt signal accordingly, wherein a summation of a current value of the first power shunt signal and a current value of the second power shunt signal is a fixed value.

17. The computer system as claimed in claim 16, wherein:
the first current adjustment module comprises:
a first switch module, electrically connected to the first control module and the first power input end;
a second switch module, electrically connected to the first control module and the first switch module; and
a first energy storage element, electrically connected to the first switch module and the second switch module, wherein the first control module simultaneously controls the first switch module and the second switch module to respectively turn on or off according to the first control command, so as to adjust the current value of the first power signal into the first power shunt signal accordingly, and to output the first power shunt signal to the load device via the first energy storage element;
and
the second current adjustment module comprises:
a third switch module, electrically connected to the second control module and the second power input end;
a fourth switch module, electrically connected to the second control module and the third switch module; and
a second energy storage element, electrically connected to the third switch module and the fourth switch module, wherein the second control module simultaneously controls the third switch module and the fourth switch module to respectively turn on or off according to the second control command, so as to adjust the current value of the second power signal into the second power shunt signal accordingly, and to output the second power shunt signal to the load device via the second energy storage element.

18. The computer system as claimed in claim 16, wherein the first power supply device further comprises a first voltage transformer, and the first voltage transformer is electrically connected between the first power input end and the first switch module, so as to receive the first power signal as an alternating current signal and convert it into the first power signal as a direct current signal.

19. The computer system as claimed in claim 16, wherein the second power supply device further comprises a second voltage transformer, and the second voltage transformer is electrically connected between the second power input end and the third switch module, so as to receive the second power signal as an alternating current signal and convert it into the second power signal as a direct current signal.

20. The computer system as claimed in claim 16, wherein the main control unit is connected to a first current confirmation module and a second current confirmation module, where the first current confirmation module compares and confirms whether the current value of the first power shunt signal corresponds to a predetermined current value of the first control command, and the second current confirmation module compares and confirms whether the current value of the second power shunt signal corresponds to the predetermined current value of the second control command.

21. The computer system as claimed in claim 16, wherein:
the first power supply device further comprises a first comparator, used for comparing and confirming whether the current value of the first power shunt signal corresponds to a control current value of the first control module; and
the second power supply device further comprises a second comparator, used for comparing and confirming whether the current value of the second power shunt signal corresponds to the control current value of the second control module.

22. The computer system as claimed in claim 16, wherein the main control unit is connected to a first protection module and a second protection module, wherein the first protection module prevents the second power shunt signal from reverse-flowing to the first power supply device, and the second protection module prevents the first power shunt signal from reverse-flowing to the second power supply device.

23. The computer system as claimed in claim 16, wherein:
the first power supply device further comprises a first protection switch, used for controlling the output of the first power shunt signal; and
the second power supply device further comprises a second protection switch, used for controlling the output of the second power shunt signal.

24. The computer system as claimed in claim 16, wherein the main control unit is connected to a first soft-start control module and a second soft-start control module, wherein the first soft-start control module controls the output of the first power shunt signal to protect the load device, and the second soft-start control module controls the output of the second power shunt signal to protect the load device.

25. The computer system as claimed in claim 16, wherein the main control unit further identifies a first identification code of the first power supply device and a second identification code of the second power supply device, so as to confirm that the first power supply device and the second power supply device can perform current adjustment.

26. The computer system as claimed in claim 16, wherein the main control unit further distributes the first power supply device to supply 100% of a load current, and the second power supply device to supply 0% of the load current, and controls the second power supply device to supply 100% of the load current when the first power supply device is fault.

27. The computer system as claimed in claim 26, wherein a power supply efficiency of the first power supply device is superior to a power supply efficiency of the second power supply device.
